(19) United States
(12) Patent Application Publication
(10) Pub. No.: US 2022/0300946 A1
(43) Pub. Date: Sep. 22, 2022

(54) SYSTEMS AND METHODS FOR CLOSED LOOP CREDIT CARD PROCESSING

(71) Applicant: JPMORGAN CHASE BANK, N.A., New York, NY (US)

(72) Inventors: Pritesh VELANKAR, Chicago, IL (US); Tu P. LE, Chicago, IL (US); Brian Emerson HOLCOMB, Parrish, FL (US); Christopher CLAUS, Chicago, IL (US)

(21) Appl. No.: 17/208,459

(22) Filed: Mar. 22, 2021

(51) Int. Cl. G06Q 20/34; G06Q 20/38

(52) U.S. Cl. CPC G06Q 20/351; G06Q 20/387

(57) ABSTRACT

A method may include: receiving, from a client, a request to pay a supplier for a transaction using a virtual card account number; providing the virtual card account number to a payment provider information processing apparatus for the issuer; processing the transaction with a merchant acquirer information processing apparatus that settles the transaction with the issuer information processing apparatus over a payment network and the payment network without charging an interchange fee; sending payment for the transaction to the merchant acquirer information processing apparatus; sending the payment to the payment provider information processing apparatus that does not charge an acquisition fee; receiving the payment, deducting a discount rate from the payment, and depositing the payment minus the discount rate to a supplier merchant account; and issuing a payout from a supplier merchant account to a supplier bank account.

### BACKGROUND OF THE INVENTION

### 1. Field of the Invention

Embodiments are generally related to systems and methods for closed-loop credit card processing.

### 2. Description of the Related Art

Merchants typically refuse to accept virtual card payments for several reasons, including a lengthy onboarding process to start accepting virtual card payments, the cost of virtual card acceptance, manual processing of virtual card information, and the lack of automated remittance.

### SUMMARY OF THE INVENTION

Systems and methods for closed-loop credit card processing are disclosed. According to one embodiment, in an information processing apparatus comprising at least one computer processor, a method for closed-loop credit card processing may include: (1) an issuer information processing apparatus receiving, from a client, a request to pay a supplier for a transaction using a virtual card account number; (2) the issuer information processing apparatus providing the virtual card account number to a payment provider information processing apparatus for the issuer; (3) the payment provider information processing apparatus processing the transaction with a merchant acquirer information processing apparatus, wherein the merchant acquirer information processing apparatus settles the transaction with the issuer information processing apparatus over a payment network and the payment network does not charge an interchange fee; (4) the issuer information processing apparatus sending payment for the transaction to the merchant acquirer information processing apparatus; (5) the merchant acquirer information processing apparatus sending the payment to the payment provider information processing apparatus, wherein the merchant acquirer information processing apparatus does not charge an acquisition fee; (6) the payment provider information processing apparatus receiving the payment, deducting a discount rate from the payment, and depositing the payment minus the discount rate to a supplier merchant account; and (7) the payment provider information processing apparatus issuing a payout from a supplier merchant account to a supplier bank account, wherein the payout may be an amount of the payment minus the discount rate.

In one embodiment, the payment provider information processing apparatus may pay a fee from the discount rate to the payment network.

In one embodiment, the issuer information processing apparatus, the payment provider information processing apparatus, and the merchant acquirer information processing apparatus may all be part of the same financial institution.

In one embodiment, the discount rate may be based on at least one of a number of virtual card account transactions over a period of time, a transaction dollar amount, a volume of merchant transactions, and a payment term.

In one embodiment, the method may further include enrolling the supplier with the payment provider information processing apparatus.

In one embodiment, wherein the discount rate may be dynamic.

In one embodiment, the discount rate may be based on a number of virtual card transactions, a dollar amount of transactions, and/or a volume of transactions.

In one embodiment, the payment provider information processing apparatus may pay the payment network a fee out of the discount rate.

According to another embodiment, a system for closed-loop credit card processing may include an issuer information processing apparatus; a payment provider information processing apparatus; and a merchant acquirer information processing apparatus. The issuer information processing apparatus is configured to: receive, from a client, a request to pay a supplier for a transaction using a virtual card account number; provide the virtual card account number to the payment provider information processing apparatus for the issuer; process the transaction with a merchant acquirer information processing apparatus, wherein the merchant acquirer information processing apparatus settles the transaction with the issuer information processing apparatus over a payment network and the payment network does not charge an interchange fee; send payment for the transaction to the merchant acquirer information processing apparatus; send the payment to the payment provider information processing apparatus, wherein the merchant acquirer information processing apparatus does not charge an acquisition fee; receive the payment, deduct a discount rate from the payment, and deposit the payment minus the discount rate to a supplier merchant account; and issue a payout from a supplier merchant account to a supplier bank account, wherein the payout may be an amount of the payment minus the discount rate.

In one embodiment, the payment provider information processing apparatus may be configured to pay a fee from the discount rate to the payment network.

In one embodiment, the issuer information processing apparatus, the payment provider information processing apparatus, and the merchant acquirer information processing apparatus may all be part of the same financial institution.

In one embodiment, the discount rate may be based on at least one of a number of virtual card account transactions over a period of time, a transaction dollar amount, a volume of merchant transactions, and a payment term.

In one embodiment, the payment provider information processing apparatus enrolls the supplier.

In one embodiment, the discount rate may be dynamic.

In one embodiment, the discount rate may be based on a number of virtual card transactions, a dollar amount of transactions, and/or a volume of transactions.

In one embodiment, the payment provider information processing apparatus pays the payment network a fee out of the discount rate.

According to another embodiment, a non-transitory computer readable medium having stored thereon software instructions that, when executed by a processor, may cause the processor to perform the following: receive, from a client, a request to pay a supplier for a transaction using a virtual card account number; provide the virtual card account number to the payment provider information processing apparatus for the issuer; process the transaction with a merchant acquirer information processing apparatus, wherein the merchant acquirer information processing apparatus may settle the transaction with the issuer information processing apparatus over a payment network and the payment network does not charge an interchange fee; send payment for the transaction to the merchant acquirer information processing apparatus; send the payment to the payment provider information processing apparatus, wherein the merchant acquirer information processing apparatus does not charge an acquisition fee; receive the payment, deduct a discount rate from the payment, and deposit the payment minus the discount rate to a supplier merchant account; and issue a payout from a supplier merchant account to a supplier bank account, wherein the payout may be an amount of the payment minus the discount rate.

In one embodiment, he non-transitory computer readable medium may further comprise software instructions that, when executed by a processor, cause the processor to pay a fee from the discount rate to the payment network.

In one embodiment, the discount rate may be based on at least one of a number of virtual card account transactions over a period of time, a transaction dollar amount, a volume of merchant transactions, and a payment term.

In one embodiment, the discount rate may be dynamic and may be based on a number of virtual card transactions, a dollar amount of transactions, and/or a volume of transactions.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for closed-loop credit card processing according to one embodiment; and

FIG. 2 illustrates a method for closed-loop credit card processing according to one embodiment.

### DETAILED DESCRIPTION OF PREFERRED EMBODIMENTS

Embodiments generally relate to systems and methods for closed-loop credit card processing. In one embodiment, a client may pay a supplier, such as a merchant, using a virtual card.

Embodiments may provide instant onboarding, straight-through processing, dynamic pricing, and automated remittance to suppliers. Embodiment may be used with existing payment networks (e.g., VisaNet, MasterCard network, etc.). Embodiments may further provide a single platform for a supplier view of receivables, and a new non-card revenue stream.

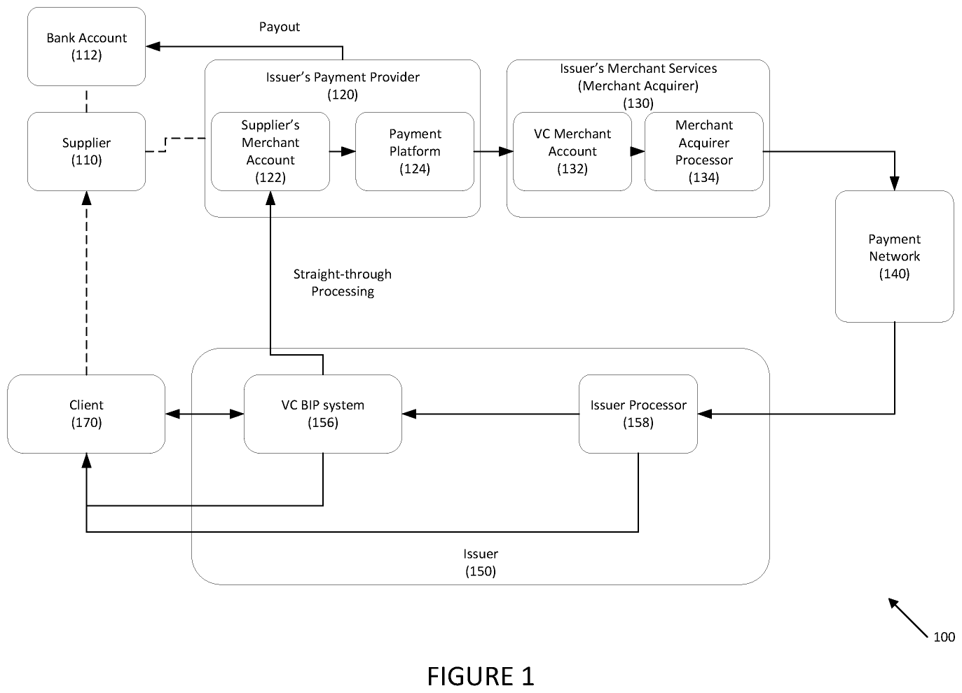

Referring to FIG. 1, a system for closed-loop credit card processing is disclosed according to one embodiment. System 100 may include supplier 110, which may be any suitable provider of a good or service (e.g., a merchant), issuer 150, issuer's payment provider 120, issuer's merchant services 130, which may function as a merchant acquirer, payment network 140, such as VisaNet, MasterCard network, etc., and client 170, which may be any suitable receiver of a good or service from supplier 110.

Supplier 110 may have a supplier bank account 112 with a financial institution (not shown).

Issuer 150 may be an issuer of financial instruments, such as a bank, a financial institution, etc. Issuer 150 may be associated with, partnered with, or may control issuer's payment provider 120 and issuer's merchant services 130. With this relationship, issuer 150 is able to control the interchange fee charged by issuer's merchant services 130.

Virtual Card Buyer Initiated Payments (“VC BIP”) system 156 may be an interface by which client 170 may request a virtual card to pay supplier 110. VC BIP system 156 may provide straight-through processing of a transaction on behalf of supplier 110 using the virtual card.

In one embodiment, the virtual card may be limited to a single use, periodic use, etc. In one embodiment, the virtual card may be identified as a virtual card based on its bank identification number, or BIN.

Supplier 110 may register with issuer's payment provider 120 and may have merchant account 122 with issuer's payment provider 120. Issuer's payment provider 120 may receive a virtual card payment from VC BIP system 156 and may process it on behalf of supplier 110 using supplier's merchant account 122.

Payment platform 124 may process the transaction with the virtual card using issuer's merchant services 130, which functions as a merchant-acquirer. Issuer's merchant services 130 may maintain virtual card (VC) merchant account 132 and may use merchant acquirer processor 134 to process the transaction. For example, VC merchant account 132 may be the parent merchant account through which all merchant sub-accounts, such as supplier merchant account 122, are processed. VC merchant account 132 may also be the account where a custom discount rate, or any other suitable fee, may be established.

Payment network 140 may be any suitable payment network, including those provided by Visa and MasterCard. In one embodiment, payment network 140 may not charge a fee, but may be compensated after the transaction.

The custom interchange fee is illustrated between merchant acquirer processor 134 and payment network 140, and between payment network 140 and issuer processor 158.

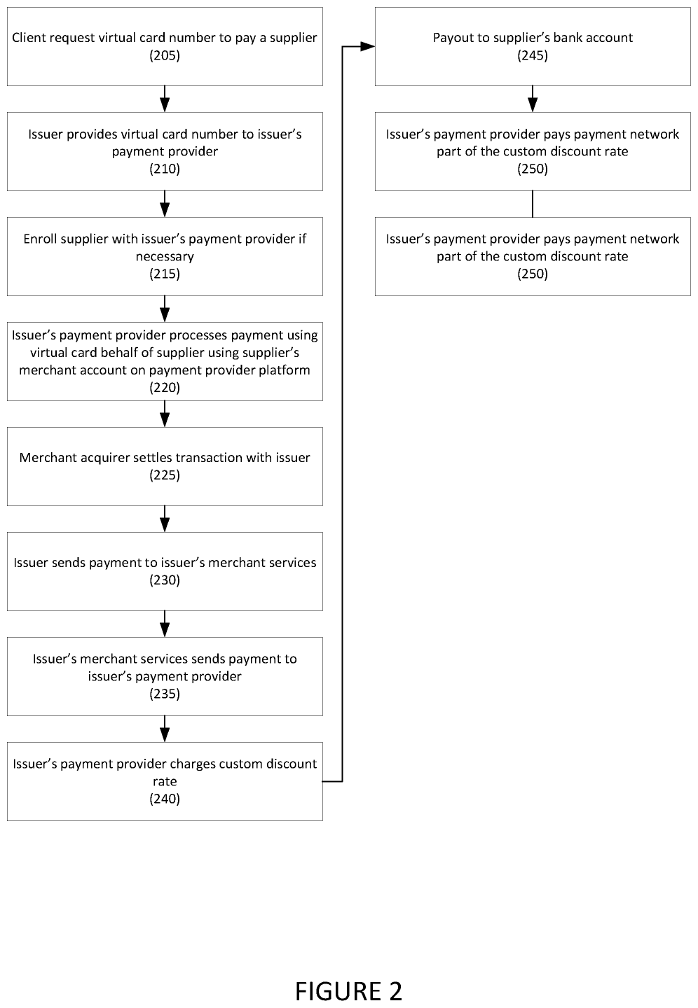

Referring to FIG. 2, a method for closed-loop credit card processing is disclosed according to one embodiment.

In step 205, a client may request a virtual card number to pay a supplier, such as a merchant that is a provider of a good or service to the client. In one embodiment, the client may identify an amount of the payment and the supplier.

In one embodiment, the virtual card number may be provided as a virtual card.

In step 210, the issuer may provide the virtual card number to the issuer's payment provider for processing.

In step 215, if the supplier is not enrolled, the supplier may be enrolled with the issuer's payment provider. In one embodiment, enrollment may be completely digital and may result in the creation of a supplier merchant account with the issuer's payment provider.

In step 220, using the virtual card, the issuer's payment provider may process the transaction on behalf of the supplier with the issuer's merchant services as the merchant acquirer.

In step 225, the merchant acquirer may settle the transaction with the issuer over the payment network. Any suitable payment network (e.g., Visa, MasterCard) may be used. In one embodiment, the payment network may not charge an interchange fee, or it may charge a custom interchange fee.

In step 230, the issuer may send payment to the issuer's merchant services. In one embodiment, the payment may be sent in batch, individually, etc.

In step 235, the issuer's merchant services may send the payment to the issuer's payment provider. The issuer's merchant services may not charge an acquisition fee.

In step 240, the issuer's payment provider may receive the payment and charge a discount rate or fee. In one embodiment, the discount rate may be based on, for example, number of virtual card transactions, dollar amount, overall merchant volume, payment terms, etc. Any suitable factors may be considered in setting the discount rate as is necessary and/or desired.

In step 245, the issuer's payment provider may issue a payout from the supplier's merchant account to the supplier's bank account. The amount of the payout may be the payment amount minus the discount rate.

In step 250, the issuer's payment provider may pay the payment network part a fee out of the discount rate collected. In one embodiment, this fee may be a per-transaction fee, or it may be based on the dollar amount. In one embodiment, the fee may be less than the standard interchange fee that the payment network charges the merchant, for example, 12-15 basis points.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for closed-loop credit card processing, comprising:
an issuer information processing apparatus receiving, from a client, a request to pay a supplier for a transaction using a virtual card account number;
the issuer information processing apparatus providing the virtual card account number to a payment provider information processing apparatus for the issuer;
the payment provider information processing apparatus processing the transaction with a merchant acquirer information processing apparatus, wherein the merchant acquirer information processing apparatus settles the transaction with the issuer information processing apparatus over a payment network and the payment network does not charge an interchange fee;
the issuer information processing apparatus sending payment for the transaction to the merchant acquirer information processing apparatus;
the merchant acquirer information processing apparatus sending the payment to the payment provider information processing apparatus, wherein the merchant acquirer information processing apparatus does not charge an acquisition fee;
the payment provider information processing apparatus receiving the payment, deducting a discount rate from the payment, and depositing the payment minus the discount rate to a supplier merchant account; and
the payment provider information processing apparatus issuing a payout from a supplier merchant account to a supplier bank account, wherein the payout is an amount of the payment minus the discount rate.

2. The method of claim 1, further comprising:
the payment provider information processing apparatus paying a fee from the discount rate to the payment network.

3. The method of claim 1, wherein the issuer information processing apparatus, the payment provider information processing apparatus, and the merchant acquirer information processing apparatus are all part of the same financial institution.

4. The method of claim 1, wherein the discount rate is based on at least one of a number of virtual card account transactions over a period of time, a transaction dollar amount, a volume of merchant transactions, and a payment term.

5. The method of claim 1, further comprising:
enrolling the supplier with the payment provider information processing apparatus.

6. The method of claim 1, wherein the discount rate is dynamic.

7. The method of claim 6, wherein the discount rate is based on a number of virtual card transactions, a dollar amount of transactions, and/or a volume of transactions.

8. The method of claim 1, wherein the payment provider information processing apparatus pays the payment network a fee out of the discount rate.

9. A system for closed-loop credit card processing, comprising:
an issuer information processing apparatus;
a payment provider information processing apparatus; and
a merchant acquirer information processing apparatus;
wherein:
the issuer information processing apparatus is configured to receive, from a client, a request to pay a supplier for a transaction using a virtual card account number;
the issuer information processing apparatus is configured to provide the virtual card account number to the payment provider information processing apparatus for the issuer;
the payment provider information processing apparatus is configured to process the transaction with a merchant acquirer information processing apparatus, wherein the merchant acquirer information processing apparatus settles the transaction with the issuer information processing apparatus over a payment network and the payment network does not charge an interchange fee;
the issuer information processing apparatus is configured to send payment for the transaction to the merchant acquirer information processing apparatus;
the merchant acquirer information processing apparatus is configured to send the payment to the payment provider information processing apparatus, wherein the merchant acquirer information processing apparatus does not charge an acquisition fee;
the payment provider information processing apparatus is configured to receive the payment, deducts a discount rate from the payment, and deposits the payment minus the discount rate to a supplier merchant account and
the payment provider information processing apparatus is configured to issue a payout from a supplier merchant account to a supplier bank account, wherein the payout is an amount of the payment minus the discount rate.

10. The system of claim 9, wherein the payment provider information processing apparatus is configured to pay a fee from the discount rate to the payment network.

11. The system of claim 9, wherein the issuer information processing apparatus, the payment provider information processing apparatus, and the merchant acquirer information processing apparatus are all part of the same financial institution.

12. The system of claim 9, wherein the discount rate is based on at least one of a number of virtual card account transactions over a period of time, a transaction dollar amount, a volume of merchant transactions, and a payment term.

13. The system of claim 9, wherein the payment provider information processing apparatus enrolls the supplier.

14. The system of claim 9, wherein the discount rate is dynamic.

15. The system of claim 9, wherein the discount rate is based on a number of virtual card transactions, a dollar amount of transactions, and/or a volume of transactions.

16. The system of claim 9, wherein the payment provider information processing apparatus pays the payment network a fee out of the discount rate.

17. A non-transitory computer readable medium having stored thereon software instructions that, when executed by a processor, cause the processor to perform the following:
receive, from a client, a request to pay a supplier for a transaction using a virtual card account number;
provide the virtual card account number to the payment provider information processing apparatus for the issuer;
process the transaction with a merchant acquirer information processing apparatus, wherein the merchant acquirer information processing apparatus settles the transaction with the issuer information processing apparatus over a payment network and the payment network does not charge an interchange fee;
send payment for the transaction to the merchant acquirer information processing apparatus;
send the payment to the payment provider information processing apparatus, wherein the merchant acquirer information processing apparatus does not charge an acquisition fee;
receive the payment, deduct a discount rate from the payment, and deposit the payment minus the discount rate to a supplier merchant account; and
issue a payout from a supplier merchant account to a supplier bank account, wherein the payout is an amount of the payment minus the discount rate.

18. The non-transitory computer readable medium of claim 17, further comprising software instructions that, when executed by a processor, cause the processor to pay a fee from the discount rate to the payment network.

19. The non-transitory computer readable medium of claim 17, wherein the discount rate is based on at least one of a number of virtual card account transactions over a period of time, a transaction dollar amount, a volume of merchant transactions, and a payment term.

20. The non-transitory computer readable medium of claim 17, wherein the discount rate is dynamic and is based on a number of virtual card transactions, a dollar amount of transactions, and/or a volume of transactions.
